(19) United States
(12) Patent Application Publication
(10) Pub. No.: US 2020/0294329 A1
(43) Pub. Date: Sep. 17, 2020

(54) DATA COLLECTING DEVICE, DATA COLLECTING SYSTEM, DATA COLLECTING METHOD, AND ON-VEHICLE DEVICE

(71) Applicant: DENSO TEN Limited, Kobe-shi (JP)

(72) Inventors: Azusa NAKA, Kobe-shi (JP); Minoru MAEHATA, Kobe-shi (JP)

(73) Assignee: DENSO TEN Limited, Kobe-shi (JP)

(21) Appl. No.: 16/809,720

(22) Filed: Mar. 5, 2020

(30) Foreign Application Priority Data
Mar. 11, 2019 (JP) 2019-044161

(51) Int. Cl. G07C 5/08; G07C 5/00; G05B 17/02; G05D 1/00

(52) U.S. Cl. CPC G07C 5/085; G05D 1/0088; G05B 17/02; G07C 5/008

(57) ABSTRACT

A data collecting device according to one aspect of an embodiment includes a processor programmed to (a) collect, from one of vehicles in which on-vehicle devices are provided and via an on-vehicle device of the one vehicle, autonomous driving data including a state of autonomous driving of the one vehicle.

### CROSS-REFERENCE TO RELATED APPLICATION

This application is based upon and claims the benefit of priority of the prior Japanese Patent Application No. 2019-044161, filed on Mar. 11, 2019, the entire contents of which are incorporated herein by reference.

### FIELD

The embodiment discussed herein is directed to a data collecting device, a data collecting system, a data collecting method, and an on-vehicle device.

### BACKGROUND

Conventionally, there has been known a data collecting device that collects road information from on-vehicle devices provided in vehicles. Such a data collecting device selects, on the basis of positional information of vehicles, a vehicle to be a collection target of road information so as to collect road information at a desired position (see, Japanese Laid-open Patent Publication No. 2018-055581, for example).

Incidentally, a technology of executing autonomous driving control on a vehicle has become rapidly widespread for recent years. In the autonomous driving control, there presents a method for using a vehicle controlling model that is for controlling autonomous driving of a vehicle, for example. In order to appropriately generate or update the vehicle controlling model, there is desired to collect data, needed for the generation, from vehicles actually travelling on roads, for example.

However, the above-mentioned conventional technology has room for improvement in efficiently collecting data needed for generating a vehicle controlling model in autonomous driving, for example.

### SUMMARY

A data collecting device according to one aspect of an embodiment includes a processor programmed to (a) collect, from one of vehicles in which on-vehicle devices are provided and via an on-vehicle device of the one vehicle, autonomous driving data including a state of autonomous driving of the one vehicle.

### BRIEF DESCRIPTION OF DRAWINGS

A more complete appreciation of the disclosed technology and many of the attendant advantages thereof will be readily obtained as the same becomes better understood by reference to the following detailed description when considered in connection with the accompanying drawings, wherein:

FIGS. 1A to 1D are diagrams illustrating the outline of a data collecting system according to an embodiment;

FIG. 2 is a block diagram illustrating a configuration example of the data collecting system according to the embodiment;

FIG. 3 is a diagram illustrating one example of collected data;

FIG. 4 is a diagram illustrating one example of a screen of a user terminal, which is displaying a set screen of a trigger condition for collection;

FIG. 5 is a diagram illustrating one example of a screen of the user terminal, which is displaying a set screen of a type of driving data to be collected; and

FIG. 6 is a flowchart illustrating a processing procedure to be executed by a data collecting device according to the embodiment.

### DESCRIPTION OF EMBODIMENTS

Hereinafter, an embodiment of a data collecting device, a data collecting system, a data collecting method, and an on-vehicle device according to the present application will be described in detail with reference to the accompanying drawings. The present disclosure is not limited to the embodiment described in the following.

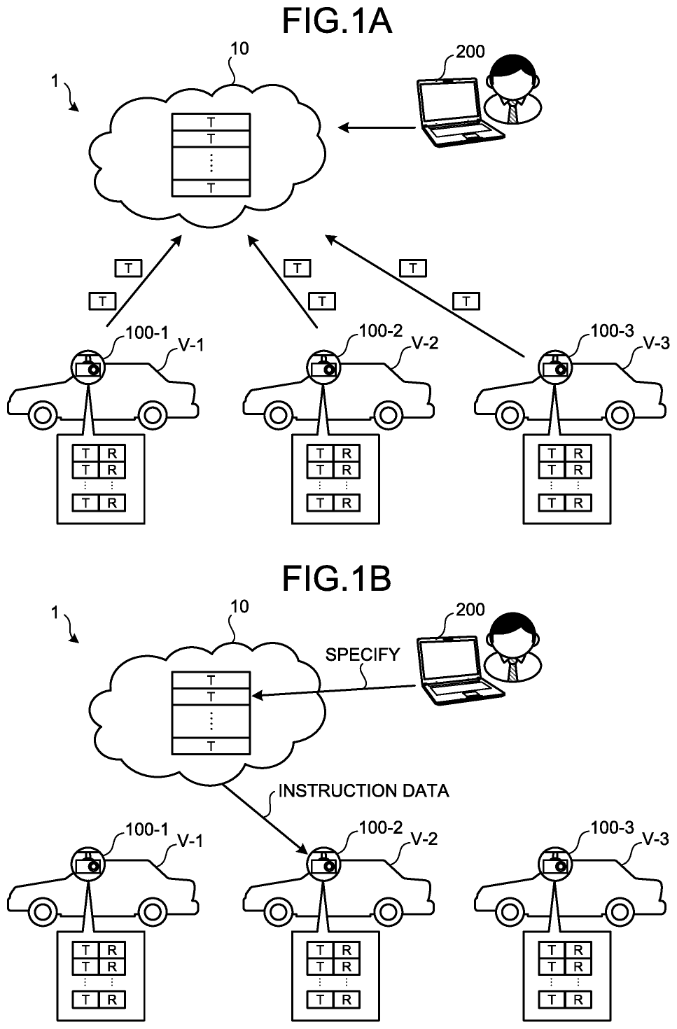

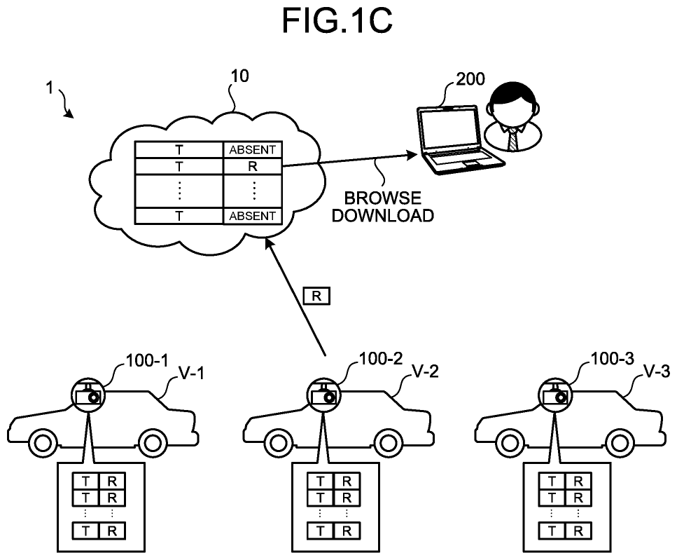

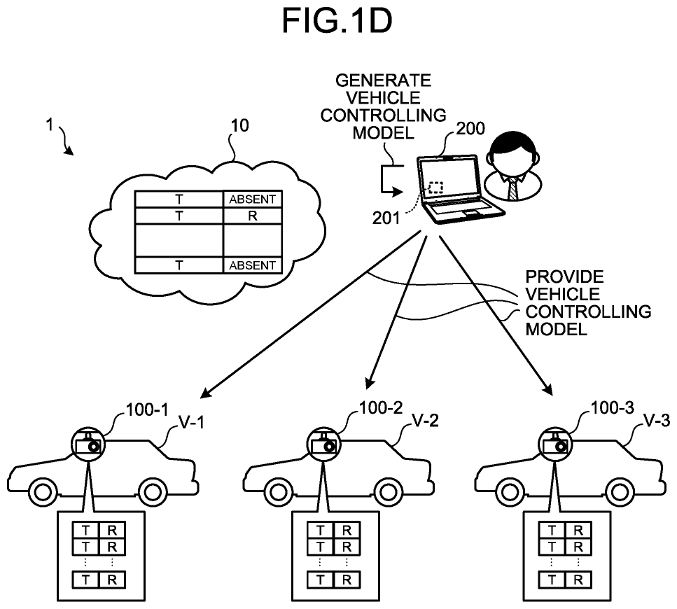

First, the outline of a data collecting system according to an embodiment will be explained with reference to FIGS. 1A to 1D. FIGS. 1A to 1D are diagrams illustrating the outline of the data collecting system according to the embodiment.

As illustrated in FIG. 1A, a data collecting system 1 according to the embodiment includes a data collecting device 10, on-vehicle devices 100-1, 100-2, 100-3 . . . that are respectively provided in vehicles V-1, V-2, V-3 . . . , and a user terminal 200. Hereinafter, when generally indicating a vehicle, it may be referred to as “vehicle V”, and when generally indicating an on-vehicle device, it may be referred to as “on-vehicle device 100”.

Hereinafter, assume that the vehicle V is an autonomous driven vehicle and a vehicle controlling model provided in the vehicle V executes thereon autonomous driving control.

The data collecting device 10 is configured as a cloud server that provides cloud services via a network such as the Internet and a mobile telephone network, so as to receive, from a data user, a collection request for data (hereinafter, may be referred to as “vehicle data”) on the vehicles V, and further to collect the vehicle data from the on-vehicle devices 100 on the basis of the received collection request. The data collecting device 10 provides the collected vehicle data to the user. In the user terminal 200 to which the vehicle data is provided, there is executed a process for generating a vehicle controlling model of autonomous driving and the like, this point will be mentioned later.

The on-vehicle device 100 is a device including various sensors such as a camera, an acceleration sensor, and a Global Positioning System (GPS) sensor; a storage device; and a microcomputer; so as to acquire a collection request that has been received by the data collecting device 10; and further to acquire vehicle data from the vehicle V in response to the collection request.

The above-mentioned camera captures the periphery of the vehicle V, for example. The acceleration sensor detects an acceleration that works on the vehicle V, and the GPS sensor detects a location of the vehicle V. For example, a dashboard camera may be employed for the on-vehicle device 100.

The on-vehicle device 100 appropriately uploads the acquired vehicle data to the data collecting device 10. When a dashboard camera is used as the on-vehicle device 100 as described above, it is possible to improve efficiency in on-vehicle components provided in the vehicle V. Note that a dashboard camera and the on-vehicle device 100 may be separately configured without using the dashboard camera as the on-vehicle device 100.

The user terminal 200 is a terminal to be used by a data user, such as a laptop-type Personal Computer (PC), a desktop-type PC, a tablet terminal, a Personal Digital Assistant (PDA), a smartphone, and a wearable device that is an information processing terminal having an eye-glasses-type or a watch-type. The user terminal 200 is one example of the terminal device.

In the data collecting system 1 according to the embodiment, the data collecting device 10 is capable of collecting vehicle data from the on-vehicle device 100 on the basis of a collection condition specified via the user terminal 200, so as to provide the collected vehicle data to the user terminal 200. Hereinafter, a series of flow until vehicle data is provided to a data user in the data collecting system 1 will be explained with reference to FIGS. 1A to 1D.

Incidentally, prior to explanation of the flow of vehicle data, autonomous driving control will be explained. For example, in a state where autonomous driving is executed in the vehicle V, when a travelling environment of the vehicle V is changed, for example, when an inter-vehicle distance is suddenly reduced by cutting of another vehicle in front of the vehicle V, it is determined in some cases that autonomous driving is not able to be continued in autonomous driving control and the autonomous driving is released.

In the autonomous driving control, it is preferable that the autonomous driving is continued as long as possible, however, in some cases the autonomous driving is determined not to be continued as described above because of a shortage of data for generating a vehicle controlling model, for example.

Thus, in order to compensate the above-mentioned shortage of data, or in order to prevent occurrence of the above-mentioned shortage of data, the data collecting system 1 according to the present embodiment is configured to efficiently collect data needed for generating a vehicle controlling model of autonomous driving. Hereinafter, details of the configuration will be explained.

As illustrated in FIG. 1A, a data user specifies a collection condition by using the user terminal 200 that is connected to the data collecting device 10.

Assume that the above-mentioned collection condition includes various parameters such as conditions to be a collection trigger, and, for example, a case where autonomous driving is changed is specified as a condition of the collection trigger. The change in autonomous driving may include a change from a state where autonomous driving is executed in a vehicle into a state where the autonomous driving is released, for example.

When a collection condition is specified, the data collecting device 10 generates data for generating tag data T that is added to actual data R (one example of “vehicle data”) to be collected and has a feature as index data to be used in searching for the actual data R and/or in grasping the outline of the actual data R. In other words, the tag data T means meta data obtained by converting the actual data R into meta information. The data for generating the tag data T is generated on the basis of an operation of a data user while using a program and/or data for generation stored in the user terminal 200 or the data collecting device 10.

The specified collection condition and the generated data for generating the tag data T are stored in the data collecting device 10, and is further delivered to the vehicle V to be a data collection target and is stored in the on-vehicle device 100.

Next, each of the on-vehicle devices 100 monitors output data from various sensors, and when an event (herein, release of autonomous driving, for example) has occurred that satisfies a stored collection condition, stores the actual data R in a storage device, such as the output data and image data. Each of the on-vehicle devices 100 generates, on the basis of the stored data for generating the tag data T and the actual data R, the tag data T corresponding to the actual data R and stores therein the generated tag data T. Each of the on-vehicle devices 100 uploads the tag data T to the data collecting device 10, and the data collecting device 10 stores therein the tag data T. In this case, the actual data R is not uploaded to the data collecting device 10. In other words, as illustrated in FIG. 1A, the data collecting device 10 is in a state where having stored therein the tag data T alone.

When a data user connects, by using the user terminal 200, to the data collecting device 10 in order to recognize a situation of collection and/or to collect the actual data R, the user terminal 200 displays meta information that is based on the tag data T collected by the data collecting device 10.

As illustrated in FIG. 1B, when the data user specifies, by using the user terminal 200, the tag data T corresponding to the actual data R to be collected, there is transmitted, via the data collecting device 10 to the corresponding on-vehicle device 100, instruction data that specifies the actual data R. Note that a case is exemplified in which there is specified the tag data T corresponding to the actual data R needed for generating a vehicle controlling model of autonomous driving; however, not limited thereto.

Next, as illustrated in FIG. 1C, the specified actual data R is uploaded from each of the on-vehicle devices 100 to the data collecting device 10, and is further collected and stored in the data collecting device 10. Incidentally, there is specified, as a condition to be the above-mentioned collection trigger, a case where autonomous driving is changed, and thus the data collecting device 10 accordingly collects the actual data R (one example of “autonomous driving data”) including a state of autonomous driving of the vehicle V.

The data user accesses, by using the user terminal 200, the actual data R stored in the data collecting device 10 so as to browse and/or download the actual data R.

In terms of data capacity of the on-vehicle device 100, it is preferable that the actual data R uploaded to the data collecting device 10 and the tag data T corresponding to the uploaded actual data R are deleted from the on-vehicle device 100 after being uploaded to the data collecting device 10.

It is preferable that the tag data T is not data obtained by simply extracting a part of the actual data R, but is converted into meta information to the extent that a data user is able to grasp the outline of the actual data R when the data user sees the tag data T so as to determine whether or not the actual data R is necessary.

As illustrated in FIG. 1D, the user terminal 200 executes a process for generating or updating a vehicle controlling model on the basis of the actual data R (hereinafter, may be referred to as “autonomous driving data”) including a state of autonomous driving of the vehicle V, which is collected by the data collecting device 10.

As described above, the data collecting device 10 according to the present embodiment is configured to collect autonomous driving data including a state of autonomous driving of the vehicle V, so that it is possible to effectively compensate a shortage of data in generating a vehicle controlling model, namely, it is possible to efficiently collect data needed for generating the vehicle controlling model in autonomous driving, for example.

The user terminal 200 includes a provision unit 201 so as to provide, to the vehicle(s) V, a vehicle controlling model that is generated or updated on the basis of autonomous driving data. Thus, the vehicle V is capable of executing autonomous driving control using the vehicle controlling model that has been appropriately generated or updated.

A provision timing of a vehicle controlling model from the user terminal 200 and/or a type of a vehicle controlling model to be provided may be appropriately set. For example, in accordance with a traveling location of the vehicle V, a vehicle controlling model appropriate for the traveling location may be provided. Furthermore, in accordance with a traveling route which the vehicle V is going to take, a vehicle controlling model according to the route may be provided. In addition to the aforementioned, there may be provided a vehicle controlling model that is appropriate for various travelling environments, such as a vehicle type of the vehicle V, the weather, a road situation, and an area.

Hereinafter, more details of the configuration example of the data collecting system 1 according to the embodiment will be explained.

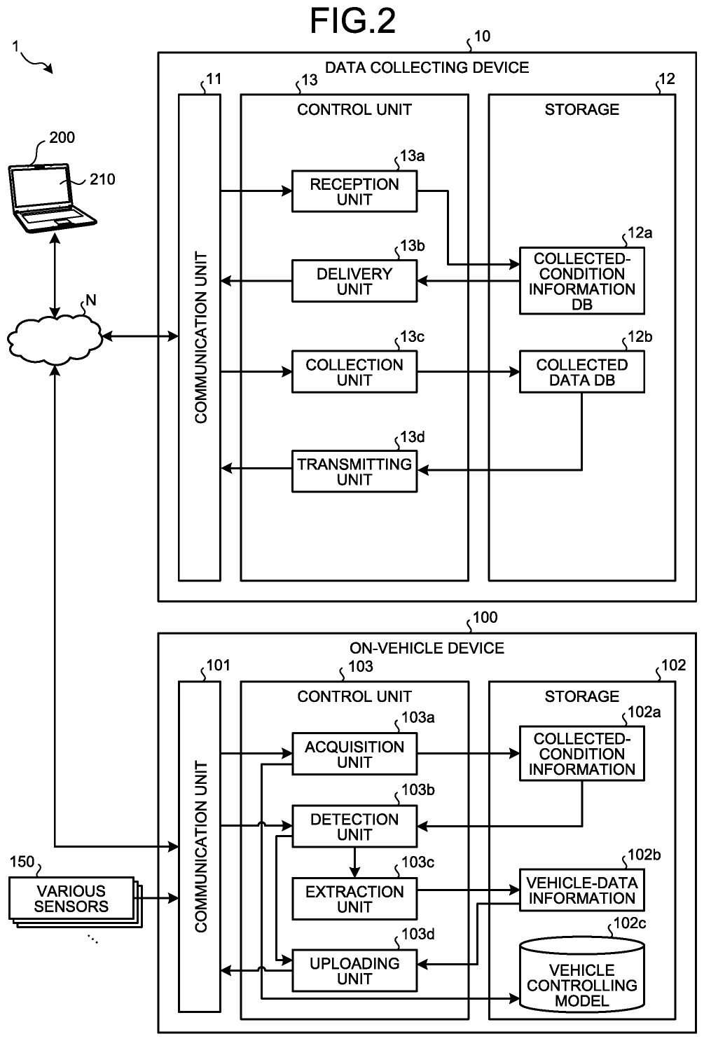

FIG. 2 is a block diagram illustrating a configuration example of the data collecting system 1 according to the embodiment. In FIG. 2, only configuration elements needed for explaining features of the embodiment are illustrated, and a description of common configuration elements is omitted.

In other words, each component of each apparatus illustrated in FIG. 2 is functionally conceptual, and thus, does not always physically configured as illustrated in the drawings. For example, a specific mode of separation or integration of each apparatus is not limited to that illustrated in the drawings. That is, all or some of the components can be configured by separating or integrating them functionally or physically in any unit, according to various types of loads, the status of use, etc.

In explanation with reference to FIG. 2, explanation of the configuration elements that have already been described may be simplified or omitted.

As illustrated in FIG. 2, the data collecting system 1 according to the embodiment includes the data collecting device 10, the on-vehicle device(s) 100, and the user terminal 200.

First, the data collecting device 10 will be explained. The data collecting device 10 includes a communication unit 11, a storage 12, and a control unit 13.

The communication unit 11 is constituted of a Network Interface Card (NIC), for example. The communication unit 11 is connected to a network N in a wired or wireless manner, and transmits and receives, via the network N, information to and from the on-vehicle device 100 and the user terminal 200.

The storage 12 is constituted of a semiconductor memory element such as a Random Access Memory (RAM) and a flash memory (Flash Memory), or a storage such as a hard disk and an optical disk; and stores, in the example illustrated in FIG. 2, therein a collected-condition information DB 12a and a collected data DB 12b.

The collected-condition information DB 12a is specified from the user terminal 200, and collection conditions received by a reception unit 13a to be mentioned later are accumulated therein. In other words, the collected-condition information DB 12a includes past actual results with respect to collection conditions.

A collection condition includes various parameters with respect to collecting of vehicle data. For example, the various parameters includes an identifier of the target vehicle V, a type of data to be collected, a condition to be a collection trigger, and a collection time interval. As one example of a condition to be a collection trigger, there presents a case where autonomous driving is changed, in more detail, a case where a state where autonomous driving is being executed is changed into a state where the autonomous driving is released.

In the collected data DB 12b, there is accumulated collected data collected from the on-vehicle devices 100 by a collection unit 13c to be mentioned later. In other words, the collected data DB 12b includes past actual results of collected data. The collected data includes the above-mentioned tag data T and the above-mentioned actual data R.

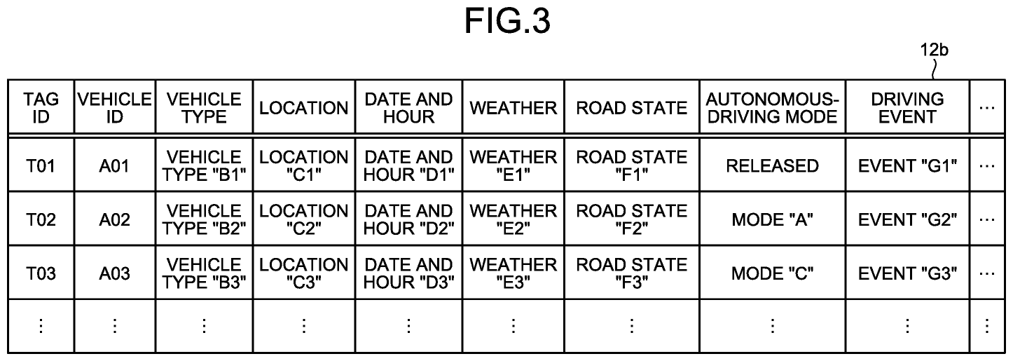

Collected data stored in the collected data DB 12b will be explained with reference to FIG. 3. FIG. 3 is a diagram illustrating one example of collected data. As illustrated in FIG. 3, collected data includes items such as “tag ID”, “vehicle ID”, “vehicle type”, “location”, “date and time”, “weather”, “road situation”, “autonomous-driving mode”, and “driving event”.

“Tag ID” is identification information that identifies the tag data T. “Vehicle ID” is identification information that identifies the vehicle V. “Vehicle type” is information indicating a vehicle type of the vehicle V. For convenience of explanation, in the example illustrated in FIG. 3, “vehicle type” is abstractly described as “vehicle type B1”; however, assume that concrete information is stored in “vehicle type B1”. Hereinafter, other information may be abstractly described.

“Location” is information indicating a location at which a collection condition is satisfied and autonomous driving data is collected. “Date and time” is information indicating a time point at which autonomous driving data is collected. “Weather” is information indicating the weather when autonomous driving data is collected. “Road situation” is a situation of a road when autonomous driving data is collected, and information indicating a situation of a road, such as a pavement type, the number of lanes, a curvature of a curve, and a road width.

“Autonomous-driving mode” is information indicating a state of autonomous driving. For example, an autonomous-driving mode is information indicating whether autonomous driving is being executed or is being released, and is information indicating a mode (Hereinafter, may be referred to as “autonomous-driving mode”, or more simply “mode”) of autonomous driving while autonomous driving is being executed.

In autonomous driving, a level is prescribed in response to a content of the autonomous driving. For example, “level 0” is “non-autonomous driving (completely-manual driving)” in which a driver performs all of a steering operation, acceleration/deceleration, and the like, and “level 1” is “driving assistance” that supports one of a steering operation and acceleration/deceleration. For example, “level 2” is “partial autonomous driving” that supports both of a steering operation and acceleration/deceleration, and “level 3” is “conditional autonomous driving” in which all operations including a steering operation are automated within a specific location and the like, and the operation is returned to a driver in case of emergency and the like. For example, “level 4” is “high autonomous driving” in which all operations including a steering operation are automated within a specific location and the like, and “level 5” is “full autonomous driving” in which all operations including a steering operation are automated even under various conditions. There presents a type of autonomous driving in which, from among driving operations, which operation is performed by autonomous driving is specified (for example, which operation/action is automated in partial autonomous driving).

As illustrated in FIG. 3, each of a mode A and a mode C in “autonomous-driving mode” of collected data includes information on a level and a type of corresponding autonomous driving. For example, a case where an autonomous-driving mode is changed may be set as a trigger included in collection conditions, which will be mentioned later.

“Driving event” is information indicating an event that has occurred with respect to the vehicle V, for example, information on cutting, traffic jam, or the like; however, not limited thereto.

A part of information in the collected data DB 12b, such as “weather” and “road state”, may be collected from an external server.

In the example illustrated in FIG. 3, data identified by tag ID “T1” indicates that a vehicle ID is “A01”, a vehicle type is “vehicle type B1”, a location is “location C1”, a date and hour is “date and hour D1”, the weather is “weather E1”, a road state is “road state F1”, an autonomous-driving mode is “released”, and a driving event is “event G1”. In the example illustrated in FIG. 3, data identified by tag ID “T2” indicates that vehicle ID is “A02”, a vehicle type is “vehicle type B2”, a location is “location C2”, a date and hour is “date and hour D2”, the weather is “weather E2”, a road state is “road state F2”, an autonomous-driving mode is “mode A”, and a driving event is “event G2”.

Returning to the explanation of FIG. 2, the control unit 13 is a controller, and, for example, a Central Processing Unit (CPU), a Micro Processing Unit (MPU), and the like execute, by using RAM as a work region, various programs stored in a storage device in the data collecting device 10 so as to realize the control unit 13. The control unit 13 is realized by using an integrated circuit such as an Application Specific Integrated Circuit (ASIC) and a Field Programmable Gate Array (FPGA).

The control unit 13 includes the reception unit 13a, a delivery unit 13b, the collection unit 13c, and a transmitting unit 13d, so as to realize or execute functions and actions of the following information processing.

The reception unit 13a receives, via the communication unit 11, a collection condition specified, by a data user, from the user terminal 200, and informs the delivery unit 13b of the received collection condition. The reception unit 13a stores, in the collected-condition information DB 12a, the collection condition specified by the data user.

As a collection trigger (event) included in the collection condition received by the reception unit 13a, there presents the above-mentioned release from autonomous driving and/or the above-mentioned change in an autonomous-driving mode, for example, and it is appropriately set by a data user. Any of various situations may be employed as a trigger in accordance with a type of data to be collected and a condition, for example, a trigger by a driving operational state such as a quick acceleration, a quick deceleration, and a sudden steering, or a trigger by a road situation such as vibration and impact.

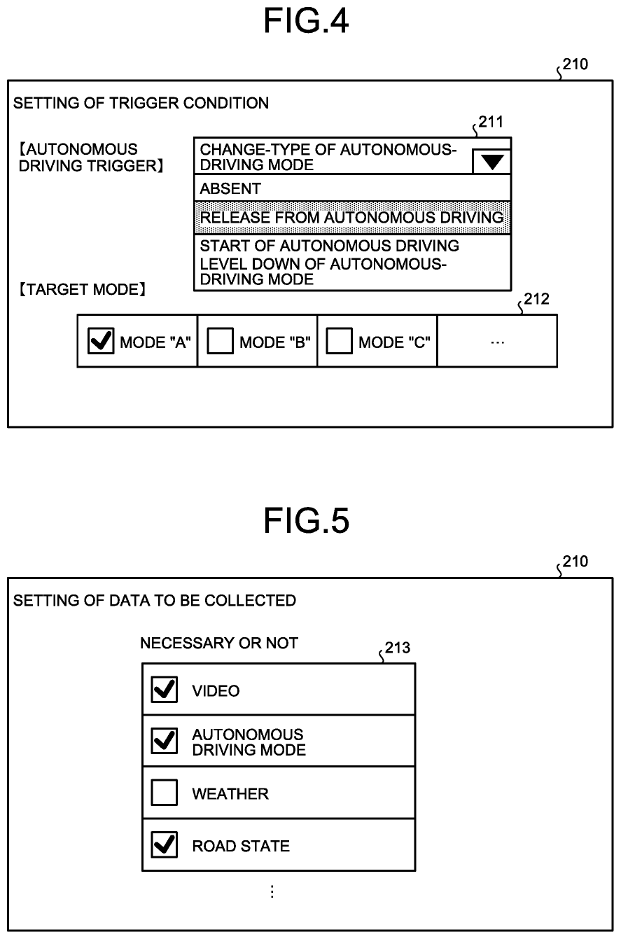

Incidentally, setting of a trigger condition for collection will be explained with reference to FIG. 4. FIG. 4 is a diagram illustrating one example of a screen 210 of the user terminal 200, which is displaying a set screen of a trigger condition for collection.

As illustrated in FIG. 4, a set screen of a trigger condition includes a change-type setting field 211 and a target-mode setting field 212. The change-type setting field 211 is a display field in which a type of change in an autonomous-driving mode is set. The target-mode setting field 212 is a display field in which an autonomous-driving mode to be collected is set.

In the example illustrated in FIG. 4, in the change-type setting field 211, a case is exemplified in which any of “absent (autonomous driving trigger)”, “release from autonomous driving”, “start of autonomous driving”, and “level down of autonomous-driving mode” may be selected from a drop-down list, and “release from autonomous driving” is selected by a data user. The types of the change-type setting field 211 illustrated in FIG. 4 are merely examples, and are not limited thereto.

In the example illustrated in FIG. 4, any of “mode A”, “mode B”, and “mode C” may be selected by using a checkbox in the target-mode setting field 212, and “mode A” is selected and set by a data user. In the target-mode setting field 212, a change from a selected mode and a change into the selected mode are set as a trigger condition. In the aforementioned, a single mode is selected in the target-mode setting field 212; however, not limited thereto, a plurality of modes may be selected.

Assume that when two conditions set in the change-type setting field 211 and the target-mode setting field 212 are satisfied (when AND condition is satisfied), for example, a collection trigger is pulled. Therefore, the example illustrated in FIG. 4 indicates that when an autonomous-driving mode is changed in such a manner that autonomous driving is released from “mode A” of autonomous-driving mode, a collection trigger is pulled. The above-mentioned setting of trigger condition is merely one example; however, not limited thereto.

Returning to the explanation of FIG. 2, a collection condition received by the reception unit 13a may include a type of driving data to be collected, and the type may be appropriately set by a data user. Setting of a type of driving data to be collected will be explained with reference to FIG. 5. FIG. 5 is a diagram illustrating one example of the screen 210 of the user terminal 200, which is displaying a set screen of a type of driving data to be collected.

As illustrated in FIG. 5, a set screen of a type of driving data to be collected includes a driving-data setting field 213. The driving-data setting field 213 is a display field in which a type of driving data to be collected is set.

In the example illustrated in FIG. 5, in the driving-data setting field 213, a case is exemplified in which any of “video”, “type of autonomous driving mode”, “weather”, “road state”, and the like may be selected from a checkbox, “video”, “type of autonomous driving mode”, and “road state” have been selected and set by a data user. Assume that driving data set in the driving-data setting field 213 is collected by the collection unit 13c to be mentioned later. In FIG. 5, a type of driving data illustrated in the driving-data setting field 213 is merely one example, and not limited thereto.

As described above, in the present embodiment, a type of driving data to be collected is selected, so that it is possible to easily select and collect driving data desired by a data user, and is further possible to prevent driving data not needed for a data user from being collected.

The delivery unit 13b is stored in the collected-condition information DB 12a, and delivers, to the vehicle V to be a target vehicle, a collection condition specified by a data user via the communication unit 11 in file format, for example.

The collection unit 13c collects, via the communication unit 11, the tag data T and the actual data R that are vehicle data acquired on the basis of the collection condition delivered from the delivery unit 13b and are uploaded from the on-vehicle device 100, and accumulates, as collected data, the collected data in the collected data DB 12b.

For example, the collection unit 13c collects autonomous driving data including a state of autonomous driving of the vehicle V, specifically, collects autonomous driving data including a change in a state of autonomous driving of the vehicle V. Thus, for example, it is possible to effectively compensate a shortage of data in generation of a vehicle controlling model by the user terminal 200, in other words, it is possible to efficiently collect data needed for generating a vehicle controlling model in autonomous driving, for example.

The collection unit 13c may collect autonomous driving data including a change from a state where autonomous driving is executed in the vehicle V into a state where the autonomous driving is released. Thus, it is possible to more effectively compensate a shortage of data in releasing autonomous driving, in other words, it is possible to more efficiently collect data needed for generating a vehicle controlling model, for example.

The collection unit 13c collects autonomous driving data used in generating a vehicle controlling model in autonomous driving of the vehicle V. Therefore, when autonomous driving data is used in generating a vehicle controlling model, an appropriate vehicle controlling model, such as a vehicle controlling model that is capable of continuing autonomous driving as long as possible, is able to be generated.

When a collection condition for executing collection of autonomous driving data is satisfied, the collection unit 13c may collect autonomous driving data from the on-vehicle device 100 of the vehicle V corresponding to a location that satisfies the collection condition. In other words, for example, when autonomous driving is released in the predetermined vehicle V and a collection condition is satisfied, the collection unit 13c may collect, in addition to autonomous driving data of the predetermined vehicle V, autonomous driving data from the on-vehicle device 100 of the vehicle V (in other words, vehicle V other than predetermined vehicle V, in which autonomous driving is not released, and whose collection condition is not satisfied) corresponding to a location that satisfies a collection condition.

Thus, for example, a cause of release from autonomous driving in the predetermined vehicle V is specified to be able to use the specified cause in generating a vehicle controlling model, even when the predetermined vehicle V and the other vehicle V are in travelling environments that are similar to each other, so that it is possible to generate an appropriate vehicle controlling model.

The collection unit 13c may collect, from the on-vehicle device 100 of the vehicle V, autonomous driving data when an autonomous-driving mode of the vehicle V is changed. Such a change in an autonomous-driving mode of the vehicle V has a possibility that its cause is a shortage of data in generating a vehicle controlling model, for example, and thus when above-mentioned configuration is employed, the shortage of data in generating a vehicle controlling model is able to be effectively compensated, in other words, data needed for generating a vehicle controlling model in autonomous driving and the like is able to be efficiently collected.

The transmitting unit 13d transmits, to the user terminal 200, collected data accumulated in the collected data DB 12b, for example.

Next, the on-vehicle device 100 will be explained. The on-vehicle device 100 includes a communication unit 101, a storage 102, and a control unit 103. As described above, various sensors 150 such as a camera, an acceleration sensor, and a GPS sensor are connected to the on-vehicle device 100.

Similarly to the communication unit 11, the communication unit 101 is realized by using an NIC, for example. The communication unit 101 is connected to the network N in a wireless manner, and transmits and receives, via the network N, information to and from the data collecting device 10. The communication unit 101 receives data output from the various sensors 150.

Similarly to the storage 12, the storage 102 is realized by using a semiconductor memory element such as a RAM and a flash memory, or a storage such as a hard disk and an optical disk, the example illustrated in FIG. 2 stores therein collected-condition information 102a, vehicle-data information 102b, and a vehicle controlling model 102c.

The collected-condition information 102a is information including a collection condition delivered from the data collecting device 10. The vehicle-data information 102b is information including vehicle data extracted by an extraction unit 103c to be mentioned later. The vehicle data includes the above-mentioned tag data T and the above-mentioned actual data R. The actual data R includes autonomous driving data and the like.

The vehicle controlling model 102c is a learning model for autonomous driving control of the vehicle V; however, not limited thereto.

Similarly to the control unit 13, the control unit 103 is a controller, and a CPU, an MPU, or the like executes, by using a RAM as a work region, various programs stored in a storage device in the on-vehicle device 100 to realize the control unit 103, for example. The control unit 103 may be realized by using an integrated circuit such as an ASIC and an FPGA.

The control unit 103 includes an acquisition unit 103a, a detection unit 103b, the extraction unit 103c, and an uploading unit 103d, so as to realize or execute functions and actions of the following information processing.

The acquisition unit 103a acquires a collection condition delivered from the data collecting device 10, and stores the delivered collection condition in the collected-condition information 102a.

The acquisition unit 103a acquires the vehicle controlling model 102c provided from the user terminal 200, and stores the provided vehicle controlling model 102c in the storage 102. Note that in the vehicle V, execution of autonomous driving control using the vehicle controlling model 102c has already been explained.

The detection unit 103b monitors output data from the various sensors 150, and detects an occurrence of an event to be a trigger in the collection condition. For example, when detecting an occurrence of an event to be a trigger for extracting vehicle data in the collection condition (herein, when autonomous driving is released), the detection unit 103b causes the extraction unit 103c to extract vehicle data. For example, when detecting an occurrence of an event to be a trigger for uploading vehicle data to the data collecting device 10 in the collection condition, the detection unit 103b causes the uploading unit 103d to upload the vehicle data.

When detecting an occurrence of a trigger for extracting vehicle data by using the detection unit 103b, the extraction unit 103c extracts vehicle data (for example, autonomous driving data) that is based on output data from the various sensors 150, and stores the extracted vehicle data in the vehicle-data information 102b. When detecting an occurrence of a trigger for stopping extraction of vehicle data by using the detection unit 103b, the extraction unit 103c stops extraction of vehicle data.

When an autonomous-driving mode of the vehicle V is changed, the extraction unit 103c may extract autonomous driving data around the time point when the autonomous-driving mode is changed. “Around a time point when the autonomous-driving mode” is changed means a predetermined time interval including a time point when an autonomous-driving mode is changed, for example; however, not limited thereto. The predetermined time interval including the time point when an autonomous-driving mode is changed may be before a change time point or after the change time point, and may preferably a predetermined time interval including both of the time points before and after the time point when an autonomous-driving mode is changed.

When detecting an occurrence of a trigger for uploading vehicle data by using the detection unit 103b, the uploading unit 103d uploads, to the data collecting device 10, vehicle data (for example, autonomous driving data and the like) stored in the vehicle-data information 102b. The uploading unit 103d is one example of a transmitting unit.

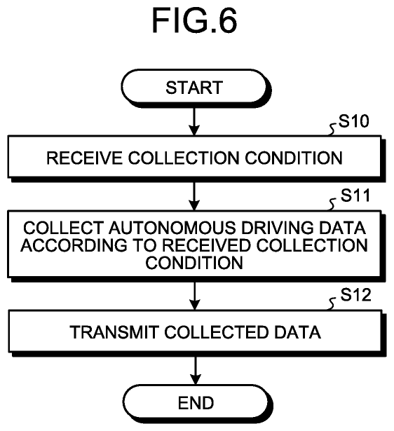

Next, a processing procedure to be executed by the data collecting device 10 according to the embodiment will be explained with reference to FIG. 6. FIG. 6 is a flowchart illustrating a processing procedure to be executed by the data collecting device 10 according to the embodiment, specifically, is a flowchart illustrating a procedure for data collecting processes to be executed by the data collecting device 10.

As illustrated in FIG. 6, the control unit 13 of the data collecting device 10 receives a collection condition specified by the user terminal 200 (Step S10). Next, the control unit 13 collects data according to the collection condition from the on-vehicle device 100 (Step S11). In the process of Step S11, when autonomous driving data is set to a type of data included in the collection condition, for example, the control unit 13 collects autonomous driving data from the on-vehicle device 100.

Subsequently, the control unit 13 transmits, to the user terminal 200, the collected data (Step S12). In the process of Step S12, when autonomous driving data is set to a type of data included in the collection condition, for example, the control unit 13 transmits, to the user terminal 200, the collected autonomous driving data. As described above, in the user terminal 200, a vehicle controlling model is generated on the basis of the autonomous driving data.

As described above, the data collecting device 10 according to the embodiment includes the collection unit 13c. The collection unit 13c collects, from one of the vehicles V in which the on-vehicle devices 100 are provided and via the on-vehicle device 100 of the one vehicle V, autonomous driving data including a state of autonomous driving of the one vehicle V. Thus, it is possible to efficiently collect data needed for generating a vehicle controlling model used in autonomous driving, for example.

In the aforementioned, the case is exemplified in which autonomous driving data is collected when autonomous driving is released by autonomous driving control; however, not limited thereto. In other words, autonomous driving data may be collected when autonomous driving is released by a driver, for example, when a brake operation is performed by a driver of the vehicle V.

In the aforementioned, a collection condition has described as a case where autonomous driving is changed, for example, a case where autonomous driving is released; however, not limited thereto, another condition may be employed.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. A data collecting device comprising:
a processor programmed to:
collect, from one of vehicles in which on-vehicle devices are provided and via an on-vehicle device of the one vehicle, autonomous driving data including a state of autonomous driving of the one vehicle.

2. The data collecting device according to claim 1, wherein
the processor is further programmed to:
collect autonomous driving data including a change in the state of autonomous driving of the vehicle.

3. The data collecting device according to claim 1, wherein
the processor is further programmed to:
collect autonomous driving data including a change from (i) a state where autonomous driving is executed in the vehicle into (ii) a state where the autonomous driving is released.

4. The data collecting device according to claim 1, wherein
the processor is further programmed to:
collect autonomous driving data that is used in generating a vehicle controlling model used in autonomous driving of the vehicles.

5. The data collecting device according to claim 1, wherein
the processor is further programmed to:
when there is satisfied a collection condition for executing a collection of the autonomous driving data, collect autonomous driving data from an on-vehicle device of a vehicle corresponding to a location in which the collection condition is satisfied.

6. The data collecting device according to claim 1, wherein
the processor is further programmed to:
collect, from the one vehicle, autonomous driving data when an autonomous-driving mode of the one vehicle is changed.

7. A data collecting system comprising:
the data collecting device according to claim 1;
an on-vehicle device that transmits the autonomous driving data to the data collecting device; and
a terminal device that acquires the autonomous driving data collected by the data collecting device.

8. The data collecting system according to claim 7, wherein
the terminal device includes a processor programmed to:
provide, to the vehicles, a vehicle controlling model that is a vehicle controlling model used in autonomous driving of the vehicles, the vehicle controlling model being generated based on the autonomous driving data collected by the data collecting device.

9. A data collecting method comprising:
collecting, from one of vehicles in which on-vehicle devices are provided and via an on-vehicle device of the one vehicle, autonomous driving data including a state of autonomous driving of the one vehicle.

10. The data collecting method according to claim 9, further comprising:
collecting, from the one vehicle, the autonomous driving data when an autonomous-driving mode of the one vehicle is changed.

11. An on-vehicle device comprising:
a processor programmed to:
extract autonomous driving data including a state of autonomous driving of a vehicle; and
transmit, to a data collecting device, the extracted autonomous driving data.

12. The on-vehicle device according to claim 11, wherein
the processor is further programmed to:
extract, when an autonomous-driving mode of a vehicle is changed, autonomous driving data around a time point when the autonomous-driving mode is changed; and
transmit, to a data collecting device, the extracted autonomous driving data.
